(19) United States
(12) Patent Application Publication
(10) Pub. No.: US 2022/0124657 A1
(43) Pub. Date: Apr. 21, 2022

(54) Mobile Terminal with Multiple Timing Advances

(71) Applicant: Telefonaktiebolaget LM Ericsson (PUBL), Stockholm (SE)

(72) Inventors: Robert Baldemair, SOLNA (SE); Boris Dortschy, HÄGERSTEN (SE); Yezi Huang, TÄBY (SE); Per-Erik Eriksson, Stockholm (SE)

(21) Appl. No.: 17/275,585

(22) PCT Filed: Sep. 26, 2019
(86) PCT No.: PCT/IB2019/058196

§ 371 Date: Mar. 11, 2021

Related U.S. Application Data
(60) Provisional application No. 62/738,672, filed on Sep. 28, 2018.

(51) Int. Cl. H04W 56/00

(52) U.S. Cl. CPC H04W 56/0045

(57) ABSTRACT

According to some embodiments, a method performed by a wireless device of communicating with more than one base station comprises: obtaining a first timing advance for wireless transmission with a first base station; obtaining a second timing advance for wireless transmission with a second base station, the second timing advance different than the first timing advance; transmitting a first wireless transmission to the first base station using the first timing advance; transmitting a second wireless transmission to the second base station using the second timing advance. The first wireless transmission and the second wireless transmission are scheduled so that a guard interval occurs and the first and second wireless transmissions do not overlap in time.

### TECHNICAL FIELD

Particular embodiments relate to wireless communication, and more specifically to a mobile terminal with multiple timing advance configurations.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Third Generation Partnership Project (3GPP) includes specifications for integrated access and backhaul (IAB). Densification via the deployment of more and more base stations (whether macro or micro base stations) is one way to satisfy the ever-increasing demand for more bandwidth/capacity in mobile networks. Because of the availability of more spectrum in the millimeter wave (mmw) band, deploying small cells that operate in this band is an attractive deployment option for increasing capacity. However, deploying fiber to the small cells, which is the usual way in which small cells are deployed, can be expensive and impractical. Thus, employing a wireless link for connecting the small cells to the operator's network is a cheaper and practical alternative. One such solution is an integrated access backhaul (IAB) network, where the operator uses part of the radio resources for the backhaul link. 3GPP long term evolution (LTE) Release 10 includes an JAB architecture where a relay node (RN) has the functionality of an LTE eNB and user equipment (UE) modem. The relay node is connected to a donor eNB that has a S1/X2 proxy functionality hiding the relay node from the rest of the network. This architecture enables the donor eNB to also be aware of the UEs behind the relay node and hide any UE mobility between donor eNB and relay node on the same donor eNB from the core network (CN). Development of Release 10 also considered other architectures, such as where the relay nodes are more transparent to the donor eNB and allocated a separate stand-alone P/S-GW node.

Fifth generation (5G) new radio (NR) may include similar architecture options. One potential difference compared to LTE (besides lower layer differences) is that NR defines a gNB-CU/DU (Centralized Unit/Distributed Unit) split that facilitates a separation of time critical RLC/MAC/PHY protocols from less time critical RRC/PDCP protocols. The split may also be applied to the integrated access and backhaul case. Other differences anticipated in NR as compared to LTE with regards to JAB is the support of multiple hops as well as the support of redundant paths.

3GPP TS 38.874 (version 0.4.0) includes several architectures for supporting user plane traffic over JAB node. Examples are described below with respect to FIGS. 1-3.

FIG. 1 is a reference diagram for 3GPP JAB architecture 1a. Architecture la leverages CU/DU-split architecture. FIG. 1 illustrates the reference diagram for a two-hop chain of IAB-nodes underneath an IAB-donor.

In the illustrated architecture, each JAB node includes a DU and a Mobile Terminal (MT). The IAB-node connects to an upstream IAB-node or the IAB-donor via the MT. The IAB-node establishes radio link control (RLC) channels to UEs and to MTs of downstream IAB-nodes via the DU. For MTs, the RLC channel may refer to a modified RLC*. An JAB node may connect to more than one upstream IAB-node or IAB-donor.

The donor also includes a DU to support UEs and MTs of downstream IAB-nodes. The IAB-donor includes a CU for the DUs of all IAB-nodes and for its own DU. Each DU on an IAB-node connects to the CU in the JAB-donor using a modified form of F1, which is referred to as F1*. F1*-U runs over RLC channels on the wireless backhaul between the MT on the serving IAB-node and the DU on the donor. F1*-U transport between MT and DU on the serving IAB-node as well as between DU and CU on the donor may be supported.

An adaptation layer is added, which includes routing information, enabling hop-by-hop forwarding. It replaces the Internet protocol (IP) functionality of the standard F1-stack. F1*-U may carry a GTP-U header for the end-to-end association between CU and DU. In a further enhancement, information carried inside the GTP-U header may be included into the adaption layer. Further, optimizations to RLC may be considered such as applying automatic repeat request (ARQ) only on the end-to-end connection opposed to hop-by-hop.

The right side of FIG. 1 illustrates two examples of such F1*-U protocol stacks. In the figure, enhancements of RLC are referred to as RLC*. The MT of each IAB-node further sustains non-access stratum (NAS) connectivity to the next generation core (NGC), e.g., for authentication of the IAB-node. It further sustains a protocol data unit (PDU)-session via the NGC, e.g., to provide the IAB-node with connectivity to the operation, administration, and management (OAM) network.

Other topics for consideration include details of F1*, the adaptation layer and RLC*, details of hop-by-hop forwarding, transport of F1-AP, and protocol translation between F1* and F1 in case the IAB-donor is split.

FIG. 2 is a reference diagram for 3GPP IAB architecture 1b. Architecture lb also leverages CU/DU-split architecture. FIG. 2 illustrates the reference diagram for a two-hop chain of IAB-nodes underneath an IAB-donor. The IAB-donor only includes one logical CU. An IAB node may connect to more than one upstream IAB-node or IAB-donor.

In the illustrated architecture, each IAB-node and the IAB-donor include the same functions as in architecture 1a. Also, as in architecture 1a, every backhaul link establishes an RLC-channel, and an adaptation layer is inserted to enable hop-by-hop forwarding of F1*.

Different from architecture 1a, the MT on each IAB-node establishes a PDU-session with a UPF residing on the donor. The MT's PDU-session carries F1* for the collocated DU. In this manner, the PDU-session provides a point-to-point link between CU and DU. On intermediate hops, the PDCP-PDUs of F1* are forwarded via adaptation layer in the same manner as described for architecture 1a. The right side of FIG. 2 illustrates an example of the F1*-U protocol stack.

FIG. 3 is a reference diagram for 3GPP IAB architecture 2a. More specifically,

FIG. 3 illustrates a reference diagram for a two-hop chain of IAB nodes for architecture 2a. In the illustrated architecture, the IAB-node includes an MT to establish an NR Uu link with a gNB on the parent IAB-node or IAB-donor. The MT sustains a PDU-session with a use plane function (UPF) that is collocated with the gNB via the NR-Uu link. In this manner, an independent PDU-session is created on every backhaul link. Each IAB-node further supports a routing function to forward data between PDU-sessions of adjacent links. This creates a forwarding plane across the wireless backhaul. Based on PDU-session type, the forwarding plane supports IP or Ethernet. If the PDU-session type is Ethernet, an IP layer can be established on top. In this manner, each IAB-node obtains IP-connectivity to the wireline backhaul network. An IAB node can connect to more than one upstream IAB-node or IAB-donor.

All IP-based interfaces such as NG, Xn, F1, N4, etc. are carried over the forwarding plane. In the case of F1, the UE-serving IAB-Node contains a DU for access links in addition to the gNB and UPF for the backhaul links. The CU for access links resides in or beyond the IAB Donor. The right side of FIG. 3 illustrates an example of the NG-U protocol stack for IP-based and for Ethernet-based PDU-session type. If the IAB-node includes a DU for UE-access, it may not be required to support PDCP-based protection on each hop since the end user data will already be protected using end to end PDCP between the UE and the CU.

For non-standalone (NSA) operation with evolved packet core (EPC), the MT is dual-connected with the network using E-UTRAN dual connectivity (EN-DC). In this case, the IAB-node's MT sustains a PDN-connection with a L-GW residing on the parent IAB-node or the IAB-donor. All IP-based interfaces such as S1, S5, X2, etc. are carried over this forwarding plane.

Other architectures are possible that include data to an access UE serving gNB or DU in an IAB node that is carried over a hop-by-hop or end-to-end PDU session. All of them have a MT as part of the IAB node that terminates the PDU session for its respective gNB or DU.

Wireless backhaul links are vulnerable to blockage, e.g., due to moving objects such as vehicles, due to seasonal changes (e.g., foliage), or due to infrastructure changes (e.g., new buildings). Such vulnerability also applies to physically stationary IAB-nodes. Also, traffic variations can create uneven load distribution on wireless backhaul links leading to local link or node congestion.

Topology adaptation refers to procedures that reconfigure the backhaul network under circumstances such as blockage or local congestion preferably without discontinuing services for UEs. Topology adaptation for physically fixed relays enables robust operation, e.g., mitigate blockage and load variation on backhaul links.

IAB may include spanning tree (ST) and/or directed acyclic graph (DAG) topologies. An example is illustrated in FIG. 4.

FIG. 4 illustrates an example of a spanning tree and a directed acyclic graph (DAG). The arrows indicate the directionality of the graph edge.

One way to provide robust operation for physically fixed relays is to provide redundant links to two or more parent nodes. An example is illustrated in FIG. 5.

FIG. 5 illustrates examples of link and route redundancy in a directed acyclic graph. DAG may include the following options: (a) the IAB-node is multi-connected, i.e., it has links to multiple parent nodes; (b) the IAB-node has multiple routes to another node, e.g. the IAB-donor; and (c) both options can be combined, i.e., the IAB-node may have redundant routes to another node via multiple parents.

Multi-connectivity or route redundancy may be used for back-up purposes. It is also possible that redundant routes are used concurrently, e.g., to achieve load balancing, reliability, etc. An example is illustrated in FIG. 6, which is a network diagram illustrating route redundancy in architecture 1.

There currently exist certain challenges. For example, a base station (eNB or gNB) requires a UE to align its transmission timing in the uplink direction according to timing alignment information provided by the base station. The timing alignment (mainly) depends on the propagation delay between the UE and base station, which depends on the distance between the UE and base station or more generally the path length. The timing alignment also depends on all UEs connected to a base station.

When a UE, such as a MT of an IAB node, is maintaining and using links to two or more base stations (or parent nodes) on overlapping signal spectrum at the same time as illustrated in FIG. 6, it is unlikely that the transmission timing to one base stations complies with the timing requirements to a second base station, because at least the wireless path length will usually not coincide.

A particular problem is which uplink transmission timing a UE should use to several base stations simultaneously. Some solutions include a UE or mobile terminal in an IAB node that measures and/or is setup with physical layer relevant parameters such as timing advance and synchronization parameters to two or more other IAB nodes. However, only a connection to one IAB node is actively maintained and used for data transmission. Other solutions include an IAB node that supports multiple MTs. The multiple terminals could individually connect to one out of two or more base stations or parent nodes at the same time. However, it requires duplicating UE or MT transceiver arrangements.

### SUMMARY

Based on the description above, certain challenges currently exist with timing advance configuration when a mobile terminal (MT) is in communication with more than one base station. Certain aspects of the present disclosure and their embodiments may provide solutions to these or other challenges. Particular embodiments include a user equipment (UE) or MT in an integrated access and backhaul (IAB) node that maintains and uses two or more links to respective base stations or IAB parent nodes at the same time by associating different timing advances and possibly other link specific parameters, such as transmission configuration state (TCI), with two or more bandwidth parts (BWP).

According to some embodiments, a method performed by a wireless device of communicating with more than one base station comprises: obtaining a first timing advance for wireless transmission with a first base station; obtaining a second timing advance for wireless transmission with a second base station, the second timing advance different than the first timing advance; transmitting a first wireless transmission to the first base station using the first timing advance; transmitting a second wireless transmission to the second base station using the second timing advance. The first wireless transmission and the second wireless transmission are scheduled so that a guard interval occurs and the first and second wireless transmissions do not overlap in time.

In particular embodiments, the first timing advance is associated with a first bandwidth part (BWP), the second timing advance is associated with a second BWP, transmissions to the first base station use the first BWP, and transmissions to the second base station use the second BWP. The method may further comprise receiving an indication to switch from using the first BWP to using the second BWP. In some embodiments, the method further comprises receiving an indication to switch from transmitting using the first timing advance to transmitting using the second timing advance. Receiving the indication may comprise receiving one of a downlink control information (DCI), a media access control (MAC) control element, and a radio resource control (RRC) message.

In particular embodiments, transmitting to the first base station occurs during a first time pattern and transmitting to the second base station occurs during a second time pattern.

In particular embodiments, the guard interval is formed by shortening the first transmission and/or by shortening the second transmission.

According to some embodiments, a wireless device is capable of communicating with more than one base station. The wireless device comprises processing circuitry operable to perform any of the wireless device methods described above.

Also disclosed is a computer program product comprising a non-transitory computer readable medium storing computer readable program code, the computer readable program code operable, when executed by processing circuitry to perform any of the methods performed by the wireless device described above.

According to some embodiments, a method performed by a network node for configuring a wireless device to communicate with more than one base station comprises: determining a guard interval for the wireless device based on a first timing advance associated with a first base station and a second timing advance associated with a second base station, the guard interval occurring between a first transmission to the first base station and a second transmission to the second base station; and scheduling the wireless device with the first wireless transmission to the first base station and the second wireless transmission to the second base station so that a guard interval occurs and the first and second wireless transmissions do not overlap in time.

In particular embodiments, the method further comprises transmitting an indication to the wireless device for the wireless device to switch from transmitting to the first base station to transmitting to the second base station. In some embodiments, the first timing advance is associated with a first BWP, the second timing advance is associated with a second BWP, transmissions to the first base station use the first BWP, transmissions to the second base station use the second BWP, and the indication for the wireless device to switch from transmitting to the first base station to transmitting to the second base station comprises an indication for the wireless device to switch from transmitting using the first BWP to transmitting using the second BWP. Transmitting the indication may comprise transmitting one of a downlink control information (DCI), a media access control (MAC) control element, and a radio resource control (RRC) message.

In particular embodiments, the method further comprises: determining a first time pattern for the wireless device to use for communicating with the first base station; determining a second time pattern for the wireless device to use for communicating with the second base station; and transmitting the first and second time patterns to the wireless device.

In particular embodiments, the guard interval is formed by shortening the first transmission and/or by shortening the second transmission.

According to some embodiments, a network node is capable of configuring a wireless device to communicate with more than one base station. The network node comprises processing circuitry operable to perform any of the network node methods described above.

Another computer program product comprises a non-transitory computer readable medium storing computer readable program code, the computer readable program code operable, when executed by processing circuitry to perform any of the methods performed by the network node described above.

Certain embodiments may provide one or more of the following technical advantages. For example, particular embodiments enable a MT of an IAB node or a UE to maintain and use links to two or more base stations (or parent nodes) at the same time, even if the links require different timing requirements and/or operate using different other link specific parameters such as power control parameters or transmission configuration states (TCI).

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a reference diagram for 3GPP JAB architecture 1a;

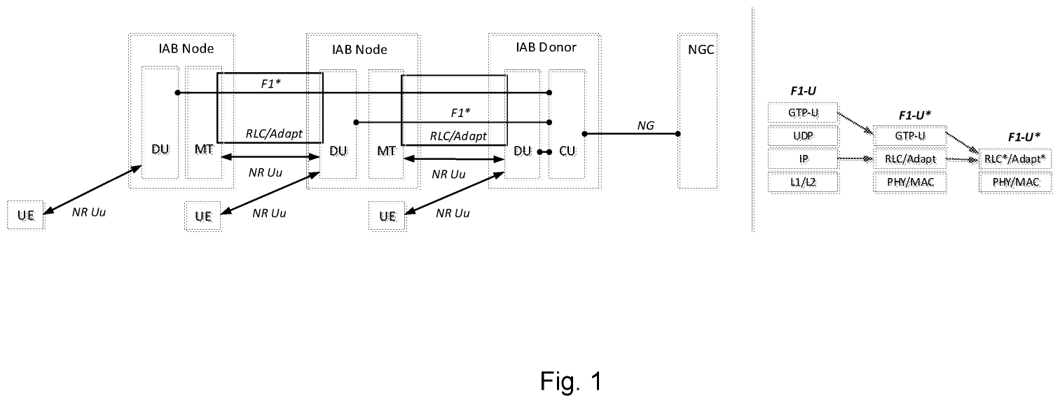

FIG. 2 is a reference diagram for 3GPP JAB architecture 1b;

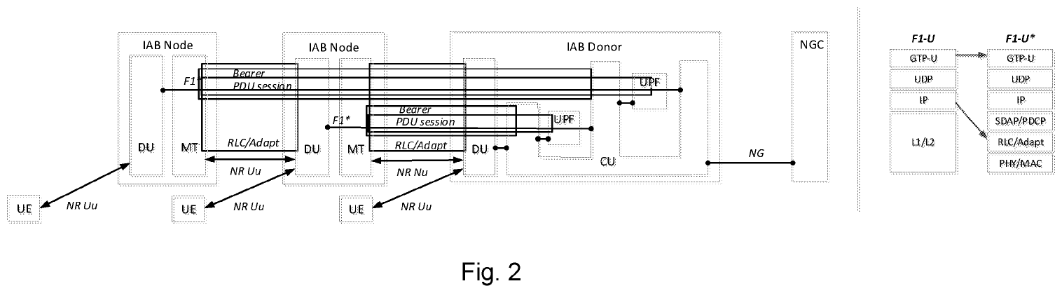

FIG. 3 is a reference diagram for 3GPP JAB architecture 2a;

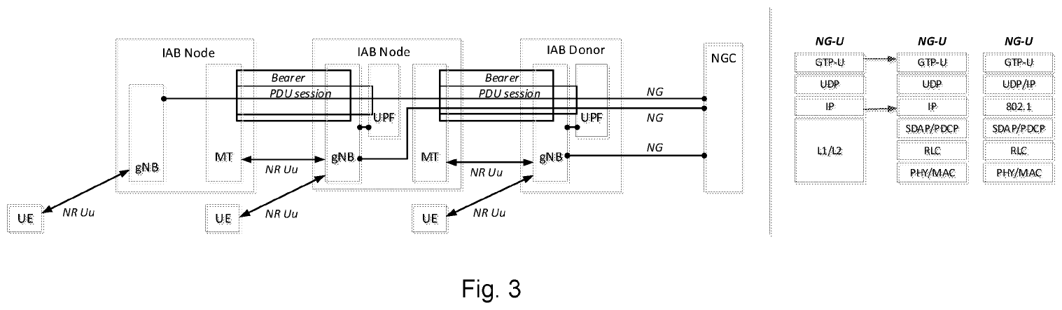

FIG. 4 illustrates an example of a spanning tree and a directed acyclic graph (DAG);

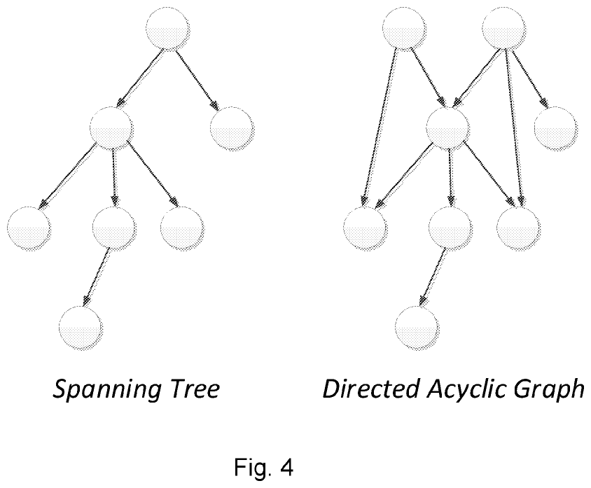

FIG. 5 illustrates examples of link and route redundancy in a directed acyclic graph;

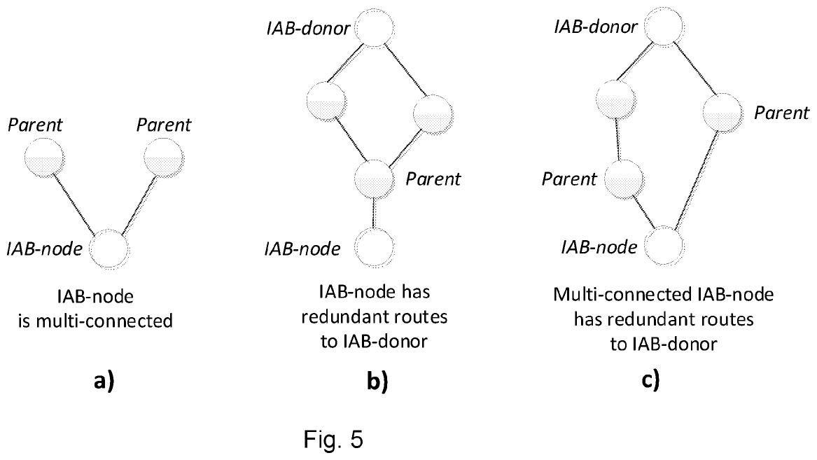

FIG. 6 is a network diagram illustrating route redundancy in architecture 1;

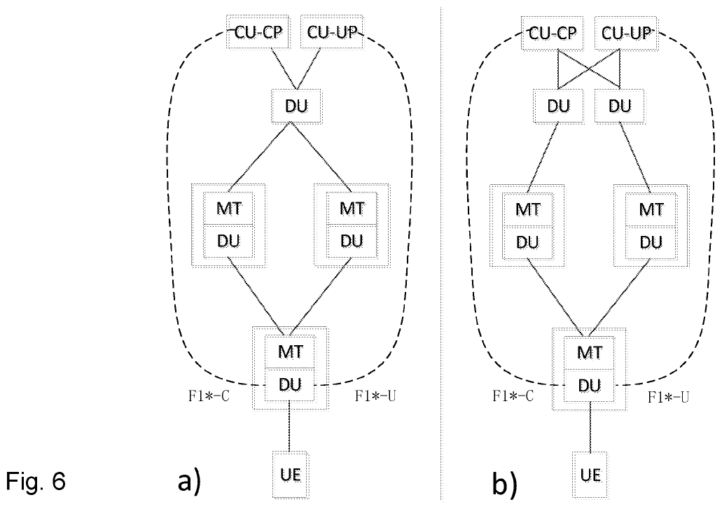

FIG. 7 is a timing diagram illustrating uplink overlap;

FIG. 8 is a timing diagram illustrating uplink transmission with a guard interval;

FIG. 9 is a block diagram illustrating an example wireless network;

FIG. 10 illustrates an example user equipment, according to certain embodiments;

FIG. 11 is flowchart illustrating an example method in a wireless device, according to certain embodiments;

FIG. 12 is a flowchart illustrating an example method in a network node, according to certain embodiments; and

FIG. 13 illustrates an example virtualization environment, according to certain embodiments.

### DETAILED DESCRIPTION

As described above, certain challenges currently exist with timing advance configuration when a mobile terminal (MT) is in communication with more than one base station. Certain aspects of the present disclosure and their embodiments may provide solutions to these or other challenges. Particular embodiments include a user equipment (UE) or a MT in an integrated access and backhaul (JAB) node that maintains and uses two or more links to respective base stations or JAB parent nodes at the same time by associating different timing advances and possibly other link specific parameters, such as transmission configuration state (TCI), with two or more bandwidth parts (BWP).

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

When a UE or a MT of an IAB node (both referred to generally as a wireless device) needs to maintain connectivity with two or more upstream nodes, multiple timing advances (TAs) are in general needed because the different upstream nodes may have different propagation times to the UE or MT of an IAB node.

When a switch occurs from one upstream node to another, an amount of time is needed to change the beam direction. Often this time is short enough that it can be absorbed in the cyclic prefix. If a second transmission following a first transmission has a larger TA than the first transmission, then the beginning of the second transmission may overlap with the end of the first transmission, which is undesirable.

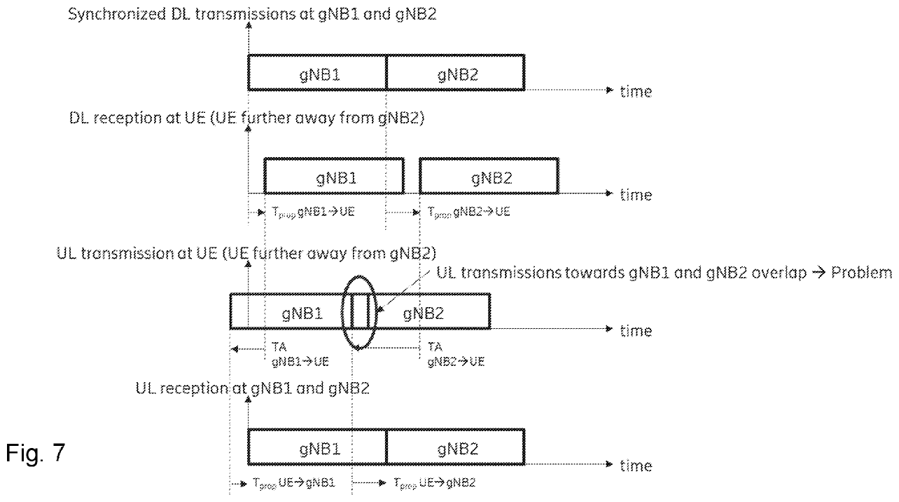

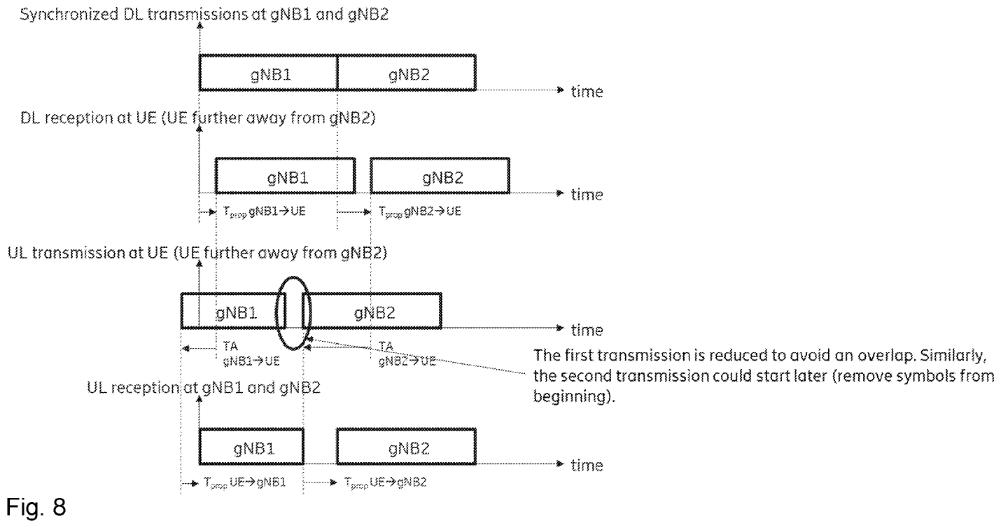

Therefore, particular embodiments include a guard time interval (GI) between transmission to different nodes. The guard time may be fixed or may be adaptive/configurable to adapt to the environment. In the extreme case, the GI needs to be as large as the largest possible TA (TX1 has TA1=0 and TX2 has TA2=TAmax). Often, however, the two TAs will be more similar in duration, and the GI may be smaller than the maximum. Examples are illustrated in FIGS. 7 and 8.

FIG. 7 is a timing diagram illustrating uplink overlap. The upper portion of FIG. 7 illustrates downlink transmissions from network nodes gNB1 and gNB2 to a UE. The time difference between when the network node transmits the downlink transmission and the UE receives the downlink transmission is referred to as the propagation delay.

The transmission delay from gNB1 to the UE is illustrated by TₚᵣₒₚgNB1→UE, and the transmission delay from gNB2 to the UE is illustrated by TₚᵣₒₚgNB2→UE. The propagation delays may differ depending on, for example, how far away the UE is from gNB1 and gNB2. In the illustrated example, the UE is farther away from gNB2 than gNB1 and thus TₚᵣₒₚgNB2→UE is larger than TₚᵣₒₚgNB1→UE.

The lower portion of FIG. 7 illustrates uplink transmissions from the UE to network nodes gNB1 and gNB2. To account for the propagation delay, the UE uses a timing advance so that uplink transmissions from the UE are received at the network node on the correct time boundary (i.e., the UE advances its transmission time to transmit earlier to account for the propagation delay).

The timing advance from the UE to gNB1 is illustrated by TAgNB1→UE, and the timing advance from the UE to gNB2 is illustrated by TAgNB2→UE. In the illustrated example, TAgNB2→UE is greater than TAgNB1→UE, which results in an overlap between the end of the transmission to gNB1 and the beginning of the transmission to gNB2. To prevent overlap, some embodiments include a guard interval, such as illustrated in FIG. 8.

FIG. 8 is a timing diagram illustrating uplink transmission with a guard interval. The upper portion of FIG. 8 illustrates downlink transmissions from network nodes gNB1 and gNB2 to a UE similar to FIG. 7.

The lower portion of FIUGRE 8 illustrates uplink transmissions from the UE to network nodes gNB1 and gNB2, similar to FIG. 7 except that a guard interval is used to prevent overlap. The guard interval may be formed by shortening the length of the first transmission (e.g., removing symbols from the end of the transmission), or by shortening the length of the second transmission (e.g., removing symbols from the beginning of the transmission).

In some embodiments, the two or more timing advances (TA) may be associated with two or more bandwidth parts (BWP). When the UE or the MT of an JAB child node switches transmission from one upstream node (such as an JAB parent node) to another, it performs a BWP switch to change the active uplink (UL) BWP. With the change of the uplink BWP, all other parameters that are associated with the BWP change. Other parameters associated with the BWP could include beam weights/precoding to steer the uplink transmission, the Transmission Configuration State (TCI), which the UE or the MT of an JAB child node uses to determine the uplink beam direction, the TA, other physical uplink shared channel (PUSCH) parameters such as numerology, demodulation reference signal (DM-RS) configuration, power control parameters, aggregation factor, frequency hopping, parameters of time-and frequency resource allocation, multiple-input multiple-output (MIMO) parameters, orthogonal frequency division multiplexing (OFDM) or discrete Fourier transform spread OFDM (DFTS-OFDM), etc.

If the transmission to different upstream nodes or JAB parent nodes is realized via BWP switching, the switching can be done dynamically via downlink control information (DCI) command. Some embodiments may include switching commands via media access control (MAC) control element (MAC CE) or radio resource control (RRC) signaling.

In particular embodiments, the UE or the MT of an IAB child node autonomously switches BWP and thus switches the receiving upstream node. In this case the upstream nodes (such as IAB parent nodes) may continuously try to detect signals from downstream nodes (the UE or the MT of an IAB child node). Some embodiments are based on configured uplink grants where at certain time instances the UE or the MT of an IAB node has pre-granted resources in at least one of the BWP. This also reduces monitoring by a parent IAB node or gNB in general.

If a single BWP is used to transmit to multiple upstream nodes (such as parent IAB nodes), the TA can be switched by means of DCI, MAC CE, or RRC signaling. Also, particular embodiments may include UE or MT autonomous switching. Some embodiments include a configured grant like concept: To reduce gNB/IAB-node monitoring, the UE or child IAB node is allowed to transmit to parent nodes following a configured time pattern. If the child node can select freely between parent nodes, each parent node needs to monitor continuously for signals from a UE or the child node

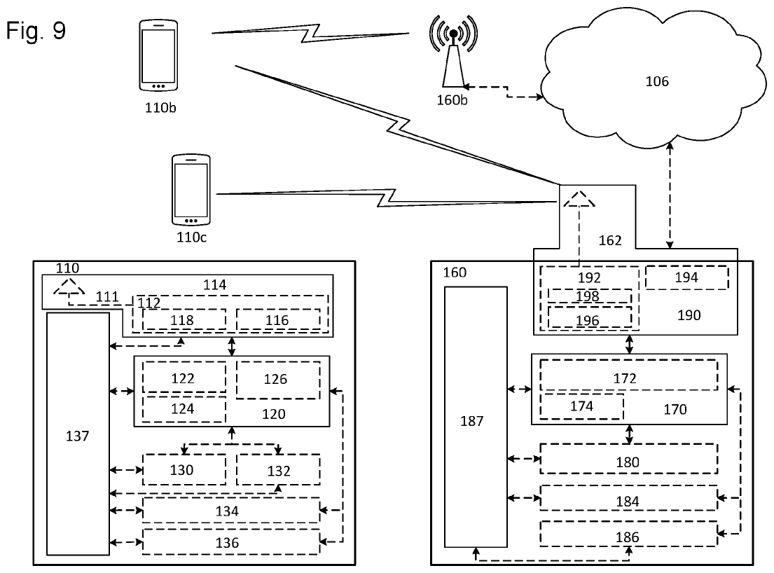

FIG. 9 illustrates an example wireless network, according to certain embodiments. The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network.

Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations.

A base station may be a relay node or a relay donor node controlling a relay. A network node may be an IAB node or parent node. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs.

As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 9, network node 160 includes processing circuitry 170, device readable medium 180, interface 190, auxiliary equipment 184, power source 186, power circuitry 187, and antenna 162. Although network node 160 illustrated in the example wireless network of FIG. 9 may represent a device that includes the illustrated combination of hardware components, other embodiments may comprise network nodes with different combinations of components.

It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node.

In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality.

For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162.

Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 190 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160.

For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 9 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air.

In some embodiments, a WD may be configured to transmit and/or receive information without direct human interaction. For instance, a WD may be designed to transmit information to a network on a predetermined schedule, when triggered by an internal or external event, or in response to requests from the network.

Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one example, the WD may be a UE implementing the 3GPP narrow band internet of things (NB-IoT) standard. Examples of such machines or devices are sensors, metering devices such as power meters, industrial machinery, or home or personal appliances (e.g. refrigerators, televisions, etc.) personal wearables (e.g., watches, fitness trackers, etc.).

In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal. A wireless device may also refer to a mobile terminal as part of an IAB node.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 114 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114.

Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips.

In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner.

In any of those embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected).

User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry.

Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

Although the subject matter described herein may be implemented in any appropriate type of system using any suitable components, the embodiments disclosed herein are described in relation to a wireless network, such as the example wireless network illustrated in FIG. 9. For simplicity, the wireless network of FIG. 9 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

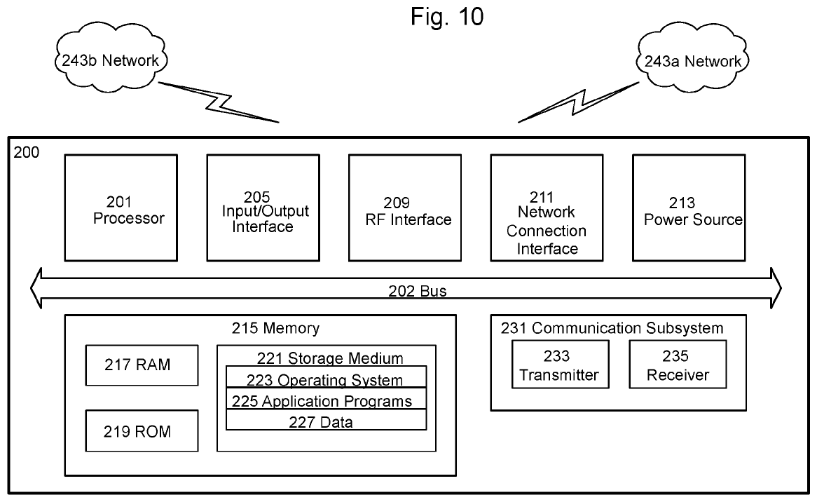

FIG. 10 illustrates an example user equipment, according to certain embodiments. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 10, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 10 is a UE, the components discussed herein are equally applicable to a WD, and vice-versa.

In FIG. 10, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may use all the components shown in FIG. 10, or only a subset of the components. The level of integration between the components may vary from one UE to another UE. Further, certain UEs may contain multiple instances of a component, such as multiple processors, memories, transceivers, transmitters, receivers, etc.

In FIG. 10, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205.

An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof.

UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 10, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory.

Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 10, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

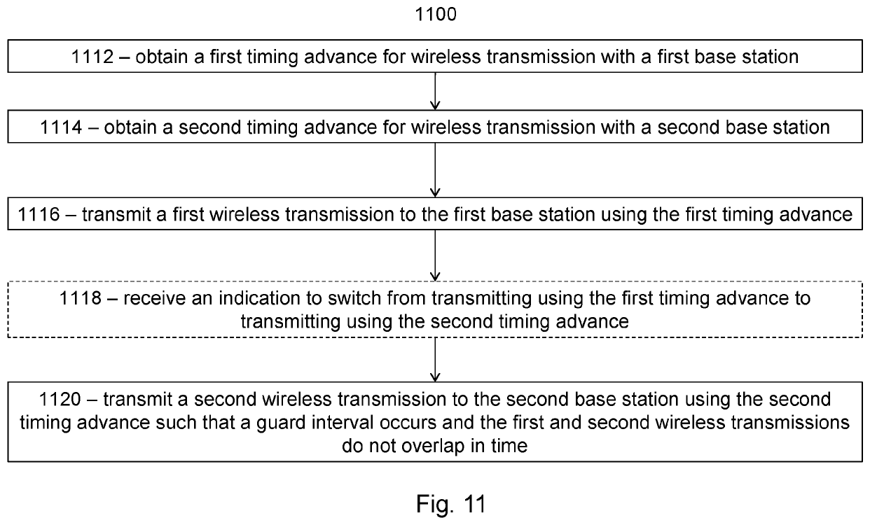

FIG. 11 is a flowchart illustrating an example method in a wireless device, according to certain embodiments. In particular embodiments, one or more steps of FIG. 11 may be performed by wireless device 110 described with respect to FIG. 9. The wireless device may comprise a UE, a MT of a relay node such as an IAB node, or any other wireless device suitable for communicating with two network nodes.

The method begins at step 1112, where the wireless device (e.g., wireless device 110) obtains a first timing advance for wireless transmission with a first base station. For example, the wireless device may receive the timing advance from the first base station, or another network node such as another base station, core network node, or any other suitable network node. In some embodiments, the first base station may comprise a relay node such as an IAB node.

At step 1114, the wireless device obtains a second timing advance for wireless transmission with a second base station. The second timing advance is different than the first timing advance. For example, the wireless device may receive the timing advance from the second base station, the first base station, or another network node such as another base station, core network node, or any other suitable network node. In some embodiments, the second base station may comprise a relay node such as an IAB node.

At step 1116, the wireless device transmits a first wireless transmission to the first base station using the first timing advance. At step 1120, the wireless device transmits a second wireless transmission to the second base station using the second timing advance. The first wireless transmission and the second wireless transmission are scheduled so that a guard interval occurs and the first and second wireless transmissions do not overlap in time. For example, a network node may schedule the first and second transmissions for the wireless device by shortening one or both of the first and second transmissions so that a guard interval occurs between the transmissions. An example of shortening the transmissions is illustrated in FIG. 8.

Some embodiments include step 1118, where the wireless device receives an indication to switch from transmitting using the first timing advance to transmitting using the second timing advance. For example, the wireless device may receive one of a downlink control information (DCI), a media access control (MAC) control element, and a radio resource control (RRC) message from a network node, such as the first base station, the second base station, or any other suitable network node.

In some embodiments, the timing advance and possibly other radio parameters may be associated with a particular bandwidth part (BWP). For example, the first timing advance may be associated with a first BWP, and the second timing advance may be associated with a second BWP. Transmissions to the first base station may use the first BWP, and transmissions to the second base station may use the second BWP. The indication to switch from transmitting using the first timing advance to transmitting using the second timing advance may comprise an indication to switch from transmitting using the first BWP to transmitting using the second BWP.

In some embodiments, the wireless device may not receive an explicit indication to switch from transmitting according to the first or second timing advance value. The wireless device may be configured with a first time pattern for transmitting to the first base station and a second time pattern for transmitting to the second base station.

Modifications, additions, or omissions may be made to method 1100 of FIG. 11. Additionally, one or more steps in the method of FIG. 11 may be performed in parallel or in any suitable order.

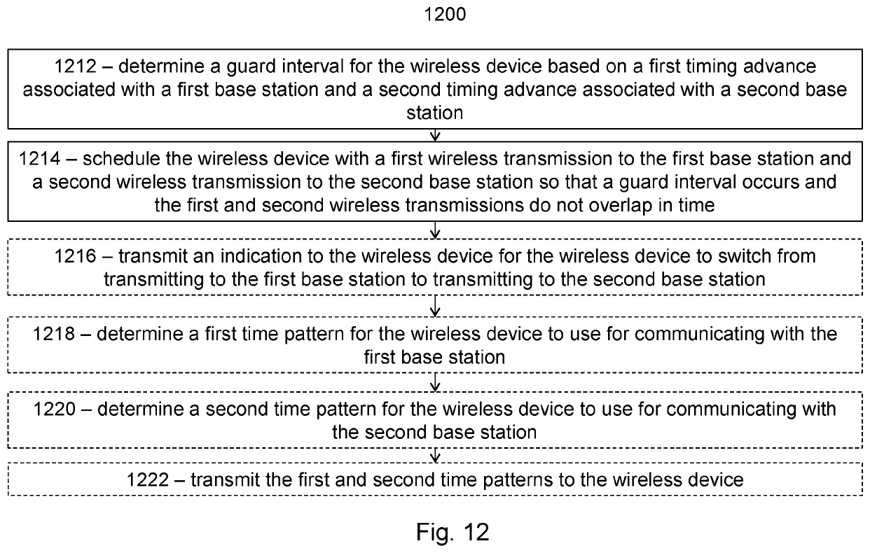

FIG. 12 is a flowchart illustrating an example method in a network node, according to certain embodiments. In particular embodiments, one or more steps of FIG. 12 may be performed by network node 160 described with respect to FIG. 9. The network node may comprise a relay node such as an IAB node.

The method begins at step 1212, where the network node (e.g., network node 160) determines a guard interval for a wireless device based on a first timing advance associated with a first base station and a second timing advance associated with a second base station. The guard interval occurs between a first transmission to the first base station and a second transmission to the second base station. The wireless device may comprise a UE, an MT of a relay node such as an IAB node, or any other suitable wireless device. An example of a guard interval is illustrated in FIG. 8.

At step 1214, the network node schedules the wireless device with the first wireless transmission to the first base station and the second wireless transmission to the second base station so that the guard interval occurs and the first and second wireless transmissions do not overlap in time. The guard interval may be formed by shortening one or both of the first and second transmissions. An example is illustrated in FIG. 8.

Some embodiments include step 1216, where the network node may transmit an indication to the wireless device for the wireless device to switch from transmitting to the first base station to transmitting to the second base station.

In some embodiments, the first timing advance is associated with a first BWP, and the second timing advance is associated with a second BWP. Transmissions to the first base station use the first BWP, and transmissions to the second base station use the second BWP. The indication for the wireless device to switch from transmitting to the first base station to transmitting to the second base station comprises an indication for the wireless device to switch from transmitting using the first BWP to transmitting using the second BWP.

In some embodiments, transmitting the indication comprises transmitting one of a DCI, a MAC control element, and a RRC message.

Some embodiments include the following additional steps. At step 1218 the network node may determine a first time pattern for the wireless device to use for communicating with the first base station and determine a second time pattern for the wireless device to use for communicating with the second base station at step 1220. At step 1222, the network node transmits the first and second time patterns to the wireless device.

Modifications, additions, or omissions may be made to method 1200 of FIG. 12. Additionally, one or more steps in the method of FIG. 12 may be performed in parallel or in any suitable order.

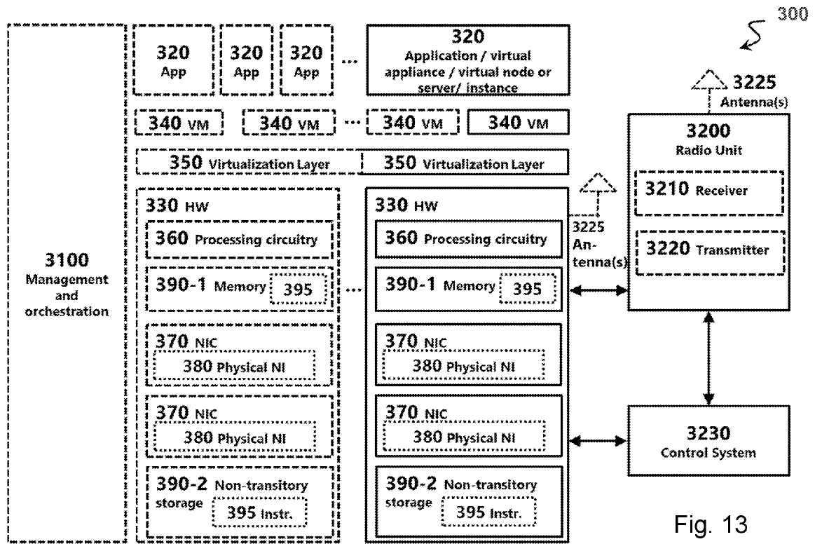

FIG. 13 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 13, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 13.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be effected with the use of control system 3230 which may alternatively be used for communication between the hardware nodes 330 and radio units 3200.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

At least some of the following abbreviations may be used in this disclosure. If there is an inconsistency between abbreviations, preference should be given to how it is used above. If listed multiple times below, the first listing should be preferred over any subsequent listing(s).
1x TT CDMA2000 1x Radio Transmission Technology
3GPP 3rd Generation Partnership Project
5G 5th Generation
5GC 5th Generation Core
5G-S-TMSI temporary identifier used in NR as a replacement of the S-TMSI in LTE
ABS Almost Blank Subframe
ARQ Automatic Repeat Request
ASN.1 Abstract Syntax Notation One
AWGN Additive White Gaussian Noise
BCCH Broadcast Control Channel
BCH Broadcast Channel
BWP Bandwidth Part
CA Carrier Aggregation
CC Carrier Component
CCCH SDU Common Control Channel SDU
CDMA Code Division Multiplexing Access
CGI Cell Global Identifier
CR Channel Impulse Response
CMAS Commercial Mobile Alert System
CN Core Network
CORESET Control Resource Set
CP Cyclic Prefix
CPICH Common Pilot Channel
CPICH Ec/No CPICH Received energy per chip divided by the power density in the band
CRC Cyclic Redundancy Check
CQI Channel Quality information
C-RNTI Cell RNTI
CSI Channel State Information
DCCH Dedicated Control Channel
DCI Downlink Control Information
div Notation indicating integer division.
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
E-SMLC Evolved-Serving Mobile Location Centre
ECGI Evolved CGI
eNB E-UTRAN NodeB
ePDCCH enhanced Physical Downlink Control Channel
EPS Evolved Packet System
E-SMLC evolved Serving Mobile Location Center
E-UTRA Evolved UTRA
E-UTRAN Evolved UTRAN
ETWS Earthquake and Tsunami Warning System
FDD Frequency Division Duplex
GERAN GSM EDGE Radio Access Network
gNB Base station in NR
GNSS Global Navigation Satellite System
GSM Global System for Mobile communication
HARQ Hybrid Automatic Repeat Request
HO Handover
HSPA High Speed Packet Access
HRPD High Rate Packet Data
ID Identity/Identifier
IMSI International Mobile Subscriber Identity
I-RNTI Inactive Radio Network Temporary Identifier
LOS Line of Sight
LPP LTE Positioning Protocol
LTE Long-Term Evolution
MAC Medium Access Control
MBMS Multimedia Broadcast Multicast Services
MBSFN Multimedia Broadcast multicast service Single Frequency
Network
MBSFN ABS MBSFN Almost Blank Subframe
MDT Minimization of Drive Tests
MIB Master Information Block
MME Mobility Management Entity
mod modulo
ms millisecond
MSC Mobile Switching Center
MSI Minimum System Information
NPDCCH Narrowband Physical Downlink Control Channel
NAS Non-Access Stratum
NGC Next Generation Core
NG-RAN Next Generation RAN
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDP Profile Delay Profile
PDSCH Physical Downlink Shared Channel
PF Paging Frame
PGW Packet Gateway
PHICH Physical Hybrid-ARQ Indicator Channel
PLMN Public Land Mobile Network
PMI Precoder Matrix Indicator
PO Paging Occasion
PRACH Physical Random Access Channel
PRB Physical Resource Block
P-RNTI Paging RNTI
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLM Radio Link Management
RMSI Remaining Minimum System Information
RNA RAN Notification Area
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SAE System Architecture Evolution
SCH Synchronization Channel
SCell Secondary Cell
SDU Service Data Unit
SFN System Frame Number
SGW Serving Gateway
SI System Information
SIB System Information Block
SIB 1 System Information Block type 1
SNR Signal to Noise Ratio
SON Self Optimized Network
SS Synchronization Signal
SSS Secondary Synchronization Signal
S-TMSI SAE-TMSI
TDD Time Division Duplex
TMSI Temporary Mobile Subscriber Identity
TDOA Time Difference of Arrival
TOA Time of Arrival
TSS Tertiary Synchronization Signal
TS Technical Specification
TSG Technical Specification Group
TTI Transmission Time Interval
UE User Equipment
UL Uplink
UMTS Universal Mobile Telecommunication System
USIM Universal Subscriber Identity Module
UTDOA Uplink Time Difference of Arrival
UTRA Universal Terrestrial Radio Access
UTRAN Universal Terrestrial Radio Access Network
WCDMA Wide CDMA
WG Working Group
WLAN Wide Local Area Network

1. A method performed by a wireless device of communicating with more than one base station, the method comprising:
obtaining a first timing advance for wireless transmission with a first base station;
obtaining a second timing advance for wireless transmission with a second base station, the second timing advance different than the first timing advance;
transmitting a first wireless transmission to the first base station using the first timing advance;
transmitting a second wireless transmission to the second base station using the second timing advance; and
wherein the first wireless transmission and the second wireless transmission are scheduled so that a guard interval occurs and the first and second wireless transmissions do not overlap in time.

2. The method of claim 1, wherein:
the first timing advance is associated with a first bandwidth part (BWP);
the second timing advance is associated with a second BWP;
transmissions to the first base station use the first BWP; and
transmissions to the second base station use the second BWP.

3. The method of claim 2, further comprising receiving an indication to switch from using the first BWP to using the second BWP.

4. The method of claim 1, further comprising receiving an indication to switch from transmitting using the first timing advance to transmitting using the second timing advance.

5. The method of claim 3, wherein receiving the indication comprises receiving one of a downlink control information (DCI), a media access control (MAC) control element, and a radio resource control (RRC) message.

6. The method of claim 1, wherein transmitting to the first base station occurs during a first time pattern and transmitting to the second base station occurs during a second time pattern.

7. The method of claim 1, wherein the guard interval is formed by shortening the first transmission.

8. The method of claim 1, wherein the guard interval is formed by shortening the second transmission.

9. A wireless device capable of communicating with more than one base station, the wireless device comprising processing circuitry operable to:
obtain a first timing advance for wireless transmission with a first base station;
obtain a second timing advance for wireless transmission with a second base station, the second timing advance different than the first timing advance;
transmit a first wireless transmission to the first base station using the first timing advance;
transmit a second wireless transmission to the second base station using the second timing advance; and
wherein the first wireless transmission and the second wireless transmission are scheduled so that a guard interval occurs and the first and second wireless transmissions do not overlap in time.

10. The wireless device of claim 9, wherein:
the first timing advance is associated with a first bandwidth part (BWP);
the second timing advance is associated with a second BWP;
transmissions to the first base station use the first BWP; and
transmissions to the second base station use the second BWP.

11. The wireless device of claim 10, the processing circuitry further operable to receive an indication to switch from using the first BWP to using the second BWP.

12. The wireless device of claim 9, the processing circuitry further operable to receive an indication to switch from transmitting using the first timing advance to transmitting using the second timing advance.

13. The wireless device of claim 11, wherein receiving the indication comprises receiving one of a downlink control information (DCI), a media access control (MAC) control element, and a radio resource control (RRC) message.

14. The wireless device of claim 9, wherein transmitting to the first base station occurs during a first time pattern and transmitting to the second base station occurs during a second time pattern.

15. The wireless device of claim 9, wherein the guard interval is formed by shortening the first transmission.

16. The wireless device of claim 9, wherein the guard interval is formed by shortening the second transmission.

17. A method performed by a network node for configuring a wireless device to communicate with more than one base station, the method comprising:
determining a guard interval for the wireless device based on a first timing advance associated with a first base station and a second timing advance associated with a second base station, the guard interval occurring between a first transmission to the first base station and a second transmission to the second base station; and
scheduling the wireless device with the first wireless transmission to the first base station and the second wireless transmission to the second base station so that the guard interval occurs and the first and second wireless transmissions do not overlap in time.

18. The method of claim 17, further comprising transmitting an indication to the wireless device for the wireless device to switch from transmitting to the first base station to transmitting to the second base station.

19. The method of claim 18, wherein:
the first timing advance is associated with a first bandwidth part (BWP);
the second timing advance is associated with a second BWP;
transmissions to the first base station use the first BWP;
transmissions to the second base station use the second BWP; and
the indication for the wireless device to switch from transmitting to the first base station to transmitting to the second base station comprises an indication for the wireless device to switch from transmitting using the first BWP to transmitting using the second BWP.

20.-23. (canceled)

24. A network node capable of configuring a wireless device to communicate with more than one base station, the network node comprising processing circuitry operable to:
determine a guard interval for the wireless device based on a first timing advance associated with a first base station and a second timing advance associated with a second base station, the guard interval occurring between a first transmission to the first base station and a second transmission to the second base station; and
schedule the wireless device with the first wireless transmission to the first base station and the second wireless transmission to the second base station so that the guard interval occurs and the first and second wireless transmissions do not overlap in time.

25. The network node of claim 24, the processing circuitry further operable to transmit an indication to the wireless device for the wireless device to switch from transmitting to the first base station to transmitting to the second base station.

26. The network node of claim 25, wherein:
the first timing advance is associated with a first bandwidth part (BWP);
the second timing advance is associated with a second BWP;
transmissions to the first base station use the first BWP;
transmissions to the second base station use the second BWP; and
the indication for the wireless device to switch from transmitting to the first base station to transmitting to the second base station comprises an indication for the wireless device to switch from transmitting using the first BWP to transmitting using the second BWP.

27. The network node of claim 25, wherein the processing circuitry is operable to transmit the indication by transmitting one of a downlink control information (DCI), a media access control (MAC) control element, and a radio resource control (RRC) message.

28. The network node of claim 24, the processing circuitry further operable to:
determine a first time pattern for the wireless device to use for communicating with the first base station;
determine a second time pattern for the wireless device to use for communicating with the second base station; and
transmit the first and second time patterns to the wireless device.

29. The network node of claim 24, wherein the guard interval is formed by shortening the first transmission.

30. The network node of claim 24, wherein the guard interval is formed by shortening the second transmission.
